(19) United States
(12) Patent Application Publication
(10) Pub. No.: US 2004/0155550 A1
(43) Pub. Date: Aug. 12, 2004

(54) Armature having teeth

(76) Inventors: Toshio Yamamoto, Kosai-city (JP); Sohei Yamada, Hamana-gun (JP); Shinji Santo, Toyohashi-city (JP); Yasuhide Ito, Kosai-city (JP); Masayuki Kuwano, Kosai-city (JP)

Correspondence Address: POSZ & BETHARDS, PLC, 11250 ROGER BACON DRIVE, SUITE 10, RESTON, VA, 20190, US

(21) Appl. No.: 10/771,460

(22) Filed: Feb. 5, 2004

(30) Foreign Application Priority Data
Feb. 6, 2003 (JP) 2003-30018

(51) Int. Cl. H02K 1/00; H02K 19/26; H02K 23/40

(52) U.S. Cl. 310/194; 310/216

(57) ABSTRACT

An armature includes a rotor core, winding wires, insulator arrangements and protective members. The rotor core includes a plurality of teeth, each of which extends in a radial direction of the rotor core. Each winding wire is wound around a corresponding one of the teeth. The insulator arrangements electrically insulate between the rotor core and the winding wires. The protective members are provided to the rotor core to protect the rotor core from mechanical damage.

### CROSS REFERENCE TO RELATED APPLICATION

This application is based on and incorporates herein by reference Japanese Patent Application No. 2003-30018 filed on Feb. 6, 2003.

### BACKGROUND OF THE INVENTION

1. Field of the Invention

The present invention relates to an armature of a motor.

2. Description of Related Art

With reference to FIG. 22, a previously proposed motor, such as a motor recited in Japanese Unexamined Patent Publication No. 2000-152532 (corresponding to U.S. Pat. No. 6,157,102), includes a rotor core, i.e., an armature core 51, which has a plurality of radially extending teeth 52 for winding wires.

The rotor core 51 disclosed, for example, in Japanese Unexamined Patent Publication No. 2000-152532, is formed by compacting magnetic powder. Thus, the rotor core 51 has little or no ductility. As a result, in a manufacturing process of the armature, when the rotor core 51 contacts another component of the motor, the rotor core 51 is easily damaged.

### SUMMARY OF THE INVENTION

The present invention addresses the above disadvantage. Thus, it is an objective of the present invention to provide an armature, which includes a rotor core and is capable of minimizing damage to the rotor core.

To achieve the objective of the present invention, there is provided an armature, which includes a rotor, a plurality of winding wires, at least one insulator arrangement and at least one protective member. The rotor core includes a plurality of teeth, each of which extends in a radial direction of the rotor core. Each winding wire is wound around a corresponding one of the teeth. The at least one insulator arrangement electrically insulates between the rotor core and the winding wires. The at least one protective member is provided to the rotor core to protect the rotor core from mechanical damage.

### BRIEF DESCRIPTION OF THE DRAWINGS

The invention, together with additional objectives, features and advantages thereof, will be best understood from the following description, the appended claims and the accompanying drawings in which:

FIG. 1 is a cross sectional view of a direct-current motor according to an embodiment of the present invention;

FIG. 2 is a cross sectional view of an armature of the direct-current motor of FIG. 1;

FIG. 3 is a perspective view of a first side insulator part of an insulator arrangement of the armature of FIG. 2;

FIG. 4 is a partial plan view of a tooth and the insulator arrangement of the armature of FIG. 2;

FIG. 5 is a perspective view of a core and a protective member of the armature of FIG. 2;

FIG. 6 is a perspective of a first core member and a second core member of the core of FIG. 5;

FIG. 7A is a plan view, showing the first core member, to which the protective member, the insulator arrangements and the winding wires are installed;

FIG. 7B is a cross sectional view along line VIIB-VIIB in FIG. 7A;

FIG. 8A is a plan view, showing the first core member, to which the protective member, the insulator arrangements and the winding wires are installed;

FIG. 8B is a cross sectional view along line VIIIB-VIIIB in FIG. 8A;

FIG. 9 is a partial perspective view, showing one modification of the insulator arrangement of the embodiment;

FIG. 10 is a perspective view similar to FIG. 5, showing one modification of the protective member of the embodiment;

FIG. 11 is a perspective view similar to FIG. 5, showing one modification of the protective member and the core of the embodiment;

FIG. 12 is a partial cross sectional view, showing one modification of the protective members of the embodiment;

FIG. 13 is a partial cross sectional view, showing one modification of the protective members and the core of the embodiment;

FIG. 14 is a partial cross sectional view, showing one modification of the protective members and the core of the embodiment;

FIG. 15 is a partial cross sectional view, showing one modification of the protective members and the core of the embodiment;

FIG. 16 is a perspective view, showing a first core member and a second core member of the core of FIG. 15;

FIG. 17 is a partial cross sectional view, showing one modification of the protective members and the core of the embodiment;

FIG. 18 is a partial cross sectional view, showing one modification of the protective members and the core of the embodiment;

FIG. 19 is a perspective view, showing a modification of the protective member of the embodiment;

FIG. 20 is a perspective view, showing a modification of the core of the embodiment;

FIG. 21 is a plan view showing a modification of the core of the embodiment; and

FIG. 22 is a plan view of a prior art core.

### DETAILED DESCRIPTION OF THE INVENTION

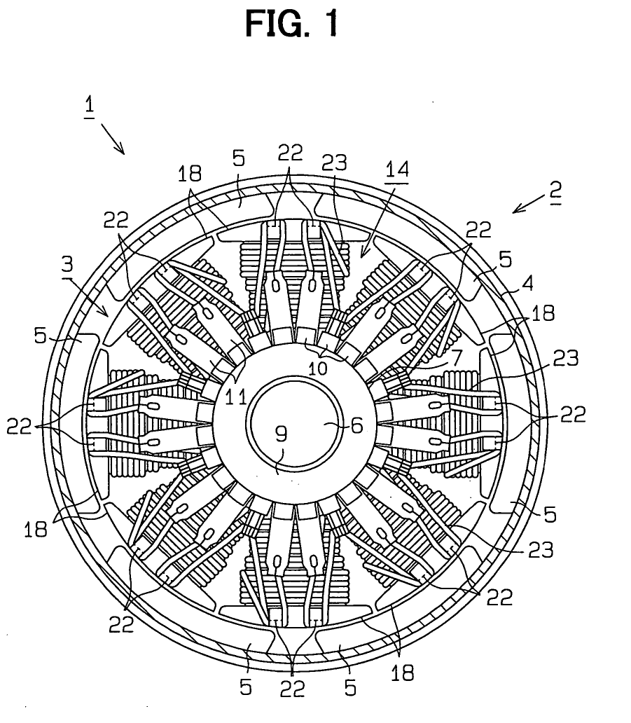

One embodiment of the present invention will be described with reference to FIGS. 1 to 8B.

As shown in FIG. 1, a motor (direct-current motor) 1 of the present embodiment includes a stator 2 and an armature 3. The stator 2 includes a cylindrical yoke 4 and a plurality of magnets 5, which respectively form corresponding magnetic poles. In this particular instance, the number of magnets 5 is six. Furthermore, the magnets 5 are secured to an inner peripheral surface of the yoke 4 and are arranged at generally equal angular intervals in a circumferential direction of the yoke 4. Each magnet 5 is a neodymium-based magnet, which includes neodymium, iron and boron.

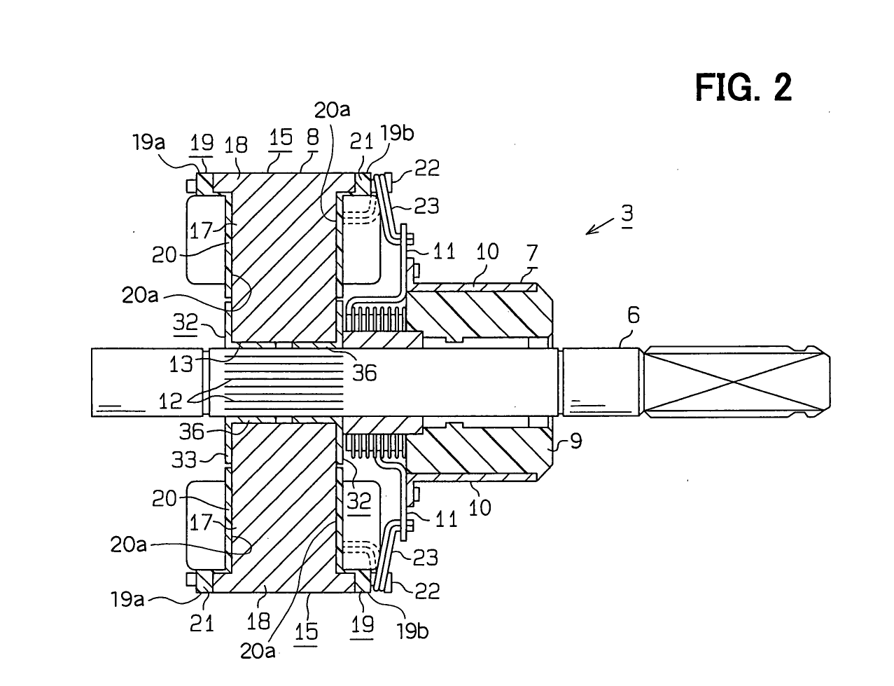

As shown in FIG. 2, the armature 3 includes a rotatable shaft 6, a commutator 7 and a rotor core 8. The rotatable shaft 6 is rotatably supported by a bearing (not shown) provided in the yoke 4. The commutator 7 and the core 8 are secured to the rotatable shaft 6. The core 8 is rotatably received in the yoke 4 such that the core 8 is surrounded by the magnets 5.

The commutator 7 includes a dielectric body 9, which is formed into a generally cylindrical shape. As shown in FIG. 1, a plurality of commutator segments 10 is secured to an outer peripheral surface of the dielectric body 9. In this particular instance, the number of commutator segments 10 is twenty four. As shown in FIG. 2, a plurality of short-circuiting wires 11 is arranged adjacent to the dielectric body 9. The commutator segments 10 are divided into a plurality of groups, and each short-circuiting wire 11 short-circuits a corresponding group of commutator segments 10 to provide the same electrical potential to the group of commutator segments 10. The commutator segments 10 are slidably engaged with power supply brushes (not shown) provided in the yoke 4, and the short-circuiting wires 11 are connected to the corresponding commutator segments 10.

As shown in FIG. 1, the direct-current motor 1 of the present embodiment has six poles and eight slots. Thus, in the twenty four commutator segments 10, each group of three commutator segments 10, each of which is arranged every eight commutator segments 10, is short-circuited by a corresponding one of the short-circuiting wires 11 and thus has the same electrical potential.

As shown in FIG. 2, a portion of an outer peripheral surface of the rotatable shaft 6, to which the core 8 is secured, i.e., to which an inner peripheral surface of each tubular portion 36 is engaged, includes a plurality of axial recesses 12. Each recess 12 extends linearly in an axial direction of the rotatable shaft 6 (i.e., in an axial direction of the armature 3). The recesses 12 are arranged at generally equal angular intervals in a circumferential direction of the rotatable shaft 6. It should be noted that in place of the recesses 12, the outer peripheral surface of the rotatable shaft 6 can be knurled. Further alternatively, the recesses 12 may be eliminated, if desired.

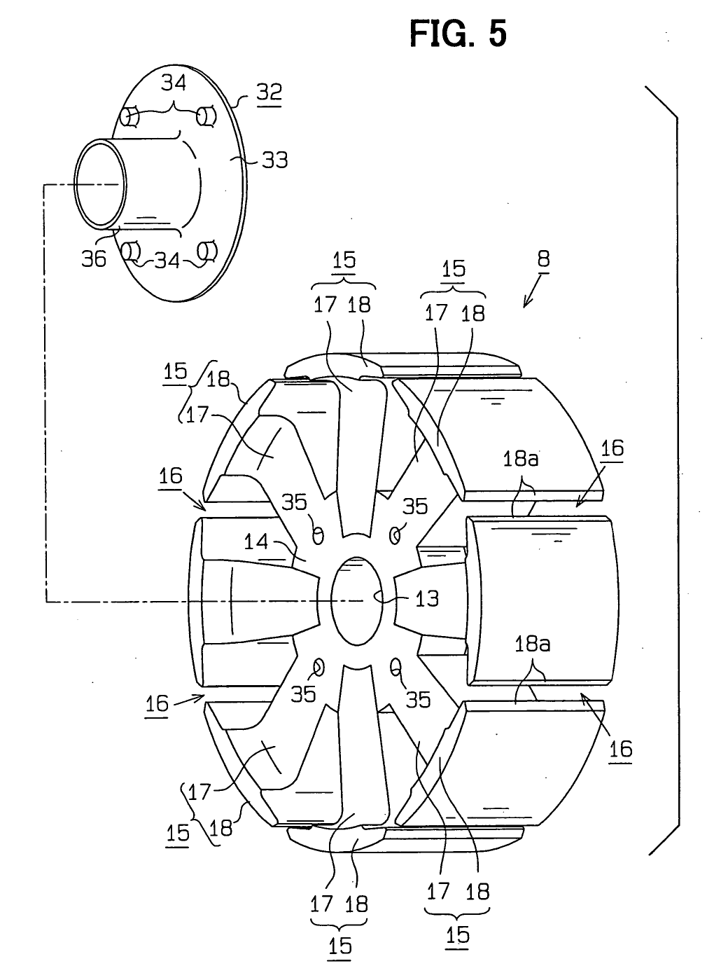

As shown in FIG. 5, the core 8 includes a center core body 14 and a plurality of teeth 15. The center core body 14 includes a through hole 13, which axially extends through the rotational center of the center core body 14. Furthermore, in this particular instance, the number of teeth 15 is eight. The teeth 15 extend radially outward from an outer peripheral part of the center core body 14 and are arranged at generally equal angular intervals. Thus, the center core body 14 includes eight slots 16, each of which is located between corresponding two of the teeth 15.

Each tooth 15 includes a tooth main body 17 and an extended portion 18. A radially inner end of the tooth main body 17 is connected to the outer peripheral part of the center core body 14, and the tooth main body 17 extends outward in a radial direction of the center core body 14 from the outer peripheral part of the center core body 14. The extended portion 18 is provided to a radially outer end of the tooth main body 17. Furthermore, the extended portion 18 extends or protrudes in a form of a flange in a circumferential direction and also in an axial direction of the armature 3. As shown in FIG. 4, a chamfered portion 18a is provided to each of opposed circumferential end edges of a radially outer end of the extended portion 18 in such a manner that the chamfered portion 18a has a decreasing radial width, which decreases toward a corresponding circumferential end of the extended portion 18.

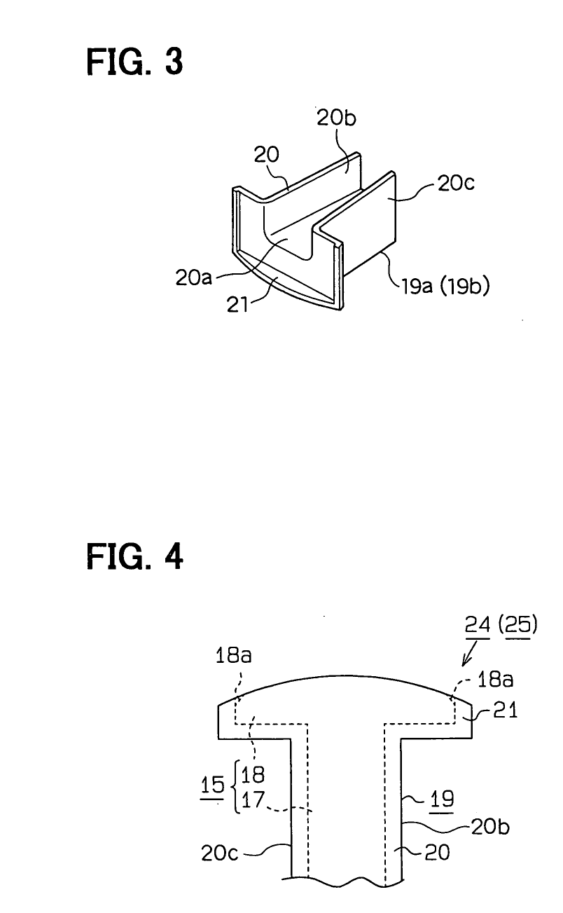

Eight insulator arrangements 19 for providing electrical insulation between the core 8 and the winding wires 23 are installed to the teeth 15, respectively. In FIG. 2, only two of the insulator arrangements 19 are shown. Each insulator arrangement 19 includes a first side insulator part 19a and a second side insulator part 19b, which are axially opposed to one another while the corresponding tooth 15 is held between the first side insulator part 19a and the second side insulator part 19b. FIG. 3 shows one of the first side insulator parts 19a. A recess 20a of the first side insulator part 19a receives the tooth main body 17 of the corresponding tooth 15, as shown in FIG. 2. Opposed lateral walls 20b, 20c of the first side insulator part 19a are engaged with side surfaces of the tooth main body 17. An axial size of each of the lateral walls 20b, 20c of the first side insulator part 19a, which is measured in the axial direction of the armature 3, is about one half of an axial size of the tooth main body 17, which is measured in the axial direction of the armature 3. Although, not depicted, the second side insulator part 19b has a structure similar to the first side insulator part 19a shown in FIG. 3 expect projections 22 (FIG. 2), which will be described later in greater detail below. When each first side insulator part 19a and the corresponding second side insulator part 19b of the insulator arrangement 19 are installed to the corresponding tooth 15, the first side insulator part 19a and the second side insulator part 19b cooperate together to form a wire winding portion 20 and a distal end insulating portion (protective member) 21. Furthermore, Upon installation of the first side and second side insulator parts 20a, 20b to the corresponding tooth 15, the lateral walls 20b, 20c of the first insulator part 19a engage the lateral walls 20b, 20c, respectively, of the axially opposed second insulator part 19b. Alternatively, the lateral walls 20b, 20c of the first insulator part 19a may be slightly axially spaced from the lateral walls 20b, 20c, respectively, of the axially opposed second insulator part 19b as long as effective insulation between the corresponding winding wire 23 and the core 8 can be achieved. With reference to FIG. 4, each wire winding portion 20 covers circumferential side surfaces and axial end surfaces of the corresponding tooth main body 17, and each distal end insulating portion 21 covers circumferential side surfaces and axial end surfaces of the corresponding extended portion 18. As shown in FIG. 2, each distal end insulating portion 21 (more specifically, a part of the distal end insulating portion 21 formed by the second side insulation part 19b) includes the projections 22, which extend in an axial direction of the direct-current motor 1. Each projection 22 is for temporarily securing a corresponding one of the winding wires 23 to the projection 22. In this particular instance, the number of projections 22 provided in each tooth 15 is two. Furthermore, each projection 22 is arranged on a commutator 7 side of the core 8.

The corresponding winding wire 23 is wound around the tooth main body 17 via the insulator arrangement 19 (specifically, the corresponding wire winding portion 20). An end of the winding wire 23, which is wound around the tooth main body 17, is wound around the projection 22 and is connected to the corresponding short-circuiting wire 11. Thus, each winding wire 23 is electrically connected to the corresponding commutator segments 10 through the corresponding short-circuiting wire 11.

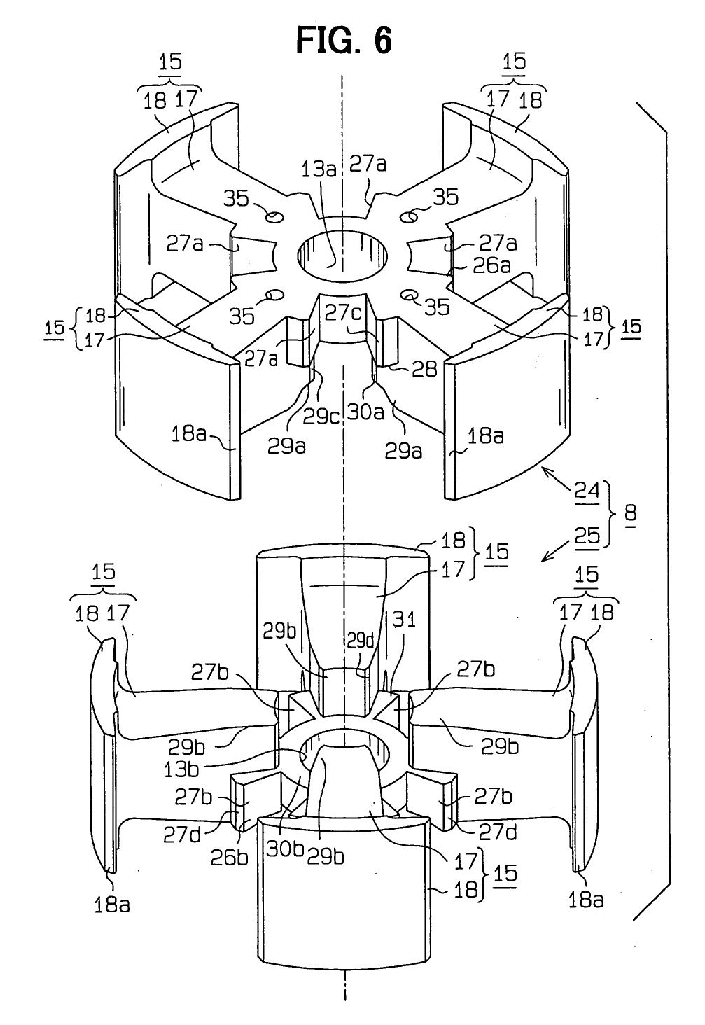

As shown in FIG. 6, the core 8 is formed upon joining a first core member (also referred to as a first split core member) 24 and a second core member (also referred to as a second split core member) 25 together. Each of the first core member 24 and the second core member 25 is formed by compression molding of magnetic powder.

The first core member 24 has a first annular portion (first core body segment) 26a, which includes a center through hole 13a as part of the through hole 13. Four of the eight teeth 15 are arranged at generally equal angular intervals (i.e., 90 degree intervals) along an outer peripheral part of the first annular portion 26a. That is, the first core member 24 includes one half of the total number of the teeth 15 (i.e., a first half of the teeth 15), which constitute part of the core 8.

An axial wall thickness of the first annular portion 26a, which is measured in the top-bottom direction in FIG. 6, is about one half of the entire axial thickness of the radially inner end of the corresponding tooth 15. An upper surface (i.e., an axial top end surface in FIG. 6) of the first annular portion 26a is flush with an upper surface (i.e., an axial top end surface in FIG. 6) of the radially inner end of each tooth 15. Specifically, the first annular portion 26a is located in an upper side part of each tooth 15 in the axial thickness direction of each tooth 15 in FIG. 6.

Four fitting recesses 27a are formed in the first annular portion 26a. The fitting recesses 27a and the teeth 15 are alternately arranged at generally equal angular intervals (i.e., 45 degree intervals) in the circumferential direction, so that each fitting recess 27a is positioned between corresponding two of the teeth 15. Two chamfered portions 27c are formed in radial opening end edges of each fitting recess 27a (i.e., two radial end edges of a radially outer opening of each fitting recess 27a). At the time of forming the core 8, fitting portions 29b (described below in greater detail) of the second core member 25 are fitted into the fitting recesses 27a, respectively.

Four fitting portions 29a are formed in a rear surface (i.e., a lower axial end surface in FIG. 6) 28 of the first annular portion 26a. A radially outer end of each fitting portion 29a is connected to the radially inner end of the corresponding tooth 15. Each fitting portion 29a is formed into a wedge shape, which has a decreasing circumferential width that decreases toward a radially inner end of the fitting portion 29a, i.e., toward the rotational axis of the core 8. An axial wall thickness of the radially outer end of the fitting portion 29a is about one half of the wall thickness of the radially inner end of each tooth 15. A lower surface (axial bottom end surface in FIG. 6) of each fitting portion 29a is flush with a lower surface (axial bottom end surface in FIG. 6) of the corresponding tooth 15. Specifically, each fitting portion 29a is located in a lower side part of each tooth 15 in the axial thickness direction of the corresponding tooth 15 in FIG. 6. Two chamfered parts 29c are provided in opposed end edges of the radially inner end of each fitting portion 29a such that the fitting portion 29a has a decreasing circumferential width, which decreases toward the radial inner end of the fitting portion 29a, i.e., toward the rotational axis of the core 8. The first annular portion 26a and the respective fitting portions 29a form an engaging recess 30a for fitting the first core member 24 and the second core member 25 together.

The second core member 25 includes a second annular portion (second core body segment) 26b, which has a center through hole 13b as a part of the through hole 13. The second annular portion 26b cooperates with the first annular portion 26a to form the center core body 14. Four of the eight teeth 15 are arranged at generally equal angular intervals (i.e., 90 degree intervals) along an outer peripheral part of the second annular portion 26b. That is, the second core member 25 includes one half of the total number of the teeth 15 (i.e., second half of the teeth), which constitute part of the core 8.

An axial thickness of the second annular portion 26b is about one half of the total axial thickness of a radially inner end of the corresponding tooth 15. A lower surface (axial bottom end surface in FIG. 6) of the outer peripheral part of the second annular portion 26b is flush with the lower surface of each tooth 15. That is, the second annular portion 26b is located in a lower side part of each corresponding tooth 15 in the axial thickness direction of each tooth 15.

Four fitting recesses 27b are formed in the second annular portion 26b. The fitting recesses 27b and the teeth 15 are alternately arranged at generally equal angular intervals (i.e., 45 degree intervals) in the circumferential direction, so that each fitting recess 27b is positioned between corresponding two of the teeth 15. Two chamfered portions 27d are formed in radial opening end edges of each fitting recess 27b (i.e., two radial end edges of a radially outer opening of each fitting recess 27b). At the time of forming the core 8, the fitting portions 29a of the first core member 24 are fitted into the fitting recesses 27b, respectively.

Four fitting portions 29b are formed in an upper surface (axial top end surface in FIG. 6) 31 of the second annular portion 26b. Each fitting portion 29b is connected to the radially inner end of the corresponding tooth 15. Each fitting portion 29b is formed into a wedge shape that has a decreasing circumferential width, which decreases toward a radially inner end of the fitting portion 29b, i.e., toward the rotational axis of the core 8. An axial wall thickness of each fitting portion 29b is one half of an axial wall thickness of the radially inner end of the corresponding tooth 15. An upper surface (axial top end surface in FIG. 6) of each fitting portion 29b is flush with an upper surface (axial top end surface in FIG. 6) of the radially inner end of the corresponding tooth 15. That is, each fitting portion 29b is located in an upper side part of each tooth 15 in the axial thickness direction of each tooth 15. Two chamfered parts 29d are formed in opposed end edges of the radially inner end of each fitting portion 29b such that the fitting portion 29b has a decreasing width, which decreases toward the radially inner end of the fitting portion 29b. At the time of forming the core 8, each fitting portion 29b is fitted into the corresponding fitting recess 27a of the first core member 24. The second annular portion 26b and the respective fitting portions 29b form an engaging recess 30b for fitting the first core member 24 and the second core member 25 together. As described above, the structure of the first core member 24 is substantially the same as that of the second core member 25.

The first core member 24 and the second core member 25 are joined together by adhesive present between the first core member 24 and the second core member 25, i.e., adhesive present between each fitting portion 29a and the corresponding fitting recess 27b and adhesive present between each fitting portion 29b and the corresponding fitting recess 27a. Here, the adhesive includes magnetic metal powder. Thus, at the time of forming the core 8, a magnetoresistance of a magnetic flux, which passes a space defined between the first core member 24 and the second core member 25, is reduced. Alternatively, each of the first core member 24 and the second core member 25 can be formed by stacking a plurality of metal plates.

Referring back to FIG. 2, two protective members 32 are provided to the core 8 to protect the core 8. Each protective member 32 is made of a resilient metal plate material. Each protective member 32 includes an annular disk portion 33, which covers a corresponding one of the opposed axial end surfaces of the core 8 around the through hole 13. An outer diameter of each annular disk portion 33 is substantially the same as an outer diameter of the first annular portion 26a and an outer diameter of the second annular portion 26b. As shown in FIG. 5, the annular disk portion 33 includes engaging projections (first type engaging portions) 34, which project in a common axial direction. In this particular instance, the number of the engaging projections 34 of the annular disk portion 33 is four. Each engaging projection 34 is formed into a generally cylindrical shape. Furthermore, the engaging projections 34 are arranged at generally equal angular intervals (i.e., 90 degree intervals) in the circumferential direction of the annular disk portion 33. The engaging projections 34 are arranged to circumferentially and radially engage with engaging recesses (second type engaging portions) 35, which are arranged in the opposed axial end surface of the core 8. In this particular embodiment, the number of the engaging recesses 35 is four. Furthermore, the engaging recesses 35 are arranged at generally equal angular intervals (i.e., 90 degree intervals) in the circumferential direction of the first annular portion 26a and of the second annular portion 26b.

A tubular portion 36, which is formed into a generally cylindrical shape, is provided in the center of the annular disk portion 33. An outer axial end of the tubular portion 36, which protrudes from the through hole 13, is connected to the annular disk portion 33. The tubular portion 36 is formed by a burring process of the metal plate material. The tubular portion 36 projects in the same direction as the respective engaging projections 34. The tubular portion 36 covers the inner peripheral surface of the through hole 13. An axial length of each tubular portion 36 provided to the corresponding annular disk portion 33 is set such that the axially opposed ends of the tubular portions 36 provided to the annular disk portions 33 are axially spaced from one another. An outer diameter of the tubular portion 36 is slightly smaller than the inner diameter of the through hole 13 of the core 8. The inner diameter of the tubular portion 36 is slightly smaller than the outer diameter of the rotatable shaft 6. With this arrangement, the rotatable shaft 6 is press fitted into the tubular portions 36.

Next, manufacturing of the armature 3 will be described.

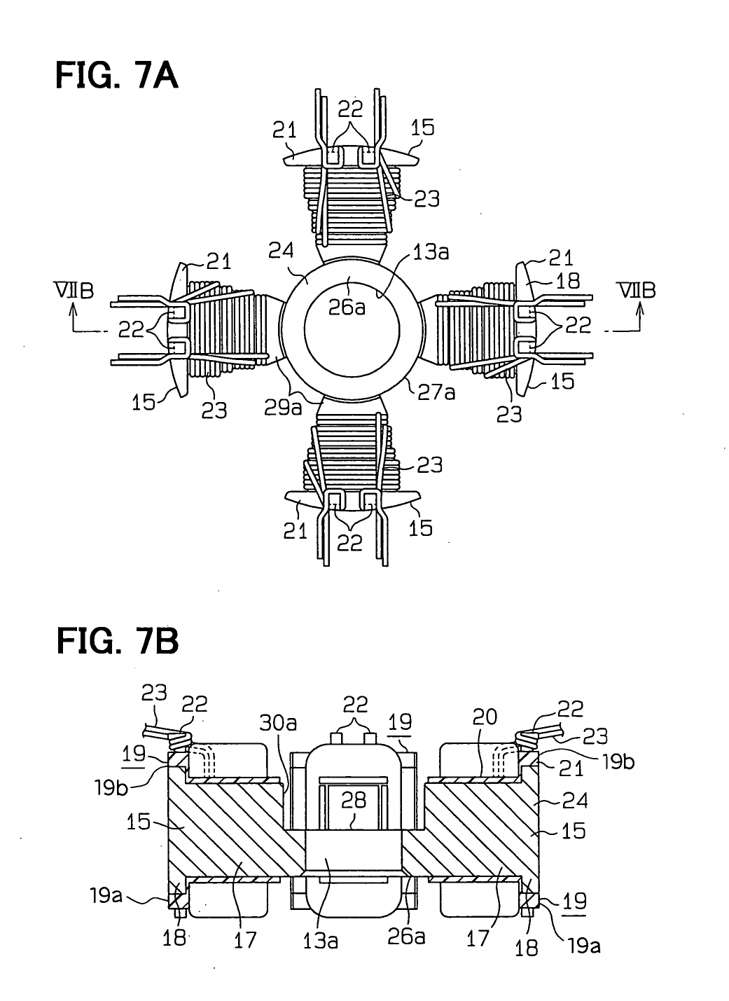

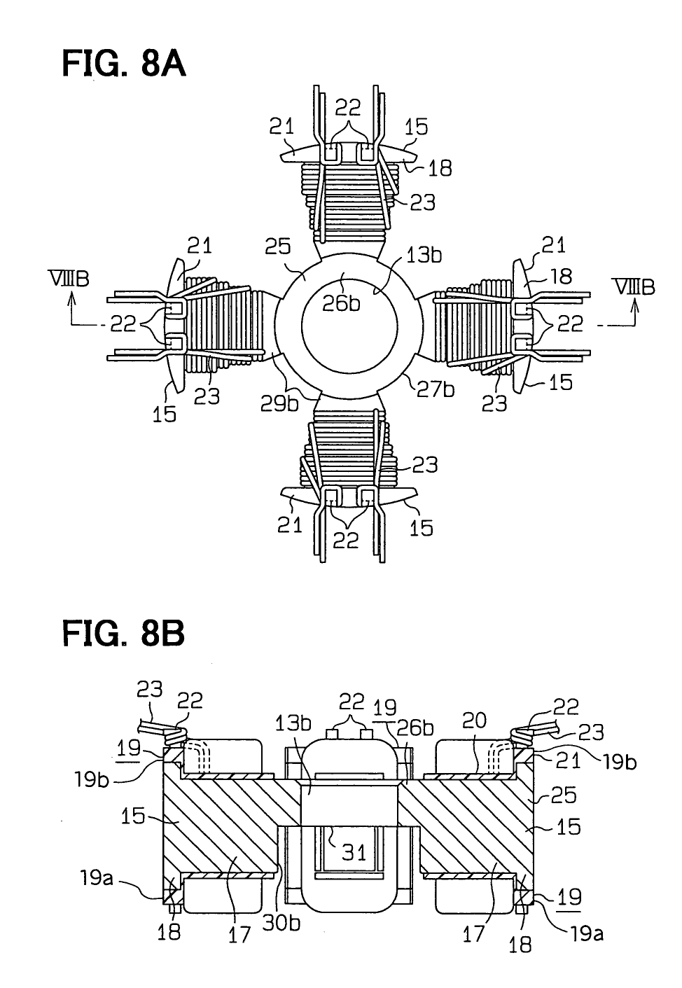

As shown in FIGS. 7A and 7B, the insulator arrangements 19 (more specifically the first side and second side insulator parts 19a, 19b) are installed to the teeth 15 of the first core member 24, and the winding wires 23 are wound around the wire winding portions 20 of the insulator arrangements 19 and are temporarily secured to the corresponding projections 22. Furthermore, as shown in FIGS. 8A and 8B, the insulator arrangements 19 (more specifically the first side and second side insulator parts 19a, 19b) are installed to the teeth 15 of the second core member 25, and the winding wires 23 are wound around the wire winding portions 20 of the insulator arrangements 19 and are temporarily secured to the corresponding projections 22.

Next, the first annular portion 26a of the first core member 24 and the second annular portion 26b of the second core member 25 are assembled in such a manner that an axis of the first annular portion 26a of the first core member 24 and an axis of the second annular portion 26b of the second core member 25 are aligned with one another, and each tooth 15 of the first annular portion 26a of the first core member 24 is displaced by 45 degrees from the corresponding tooth 15 of the second annular portion 26b of the second core member 25 in the circumferential direction. Specifically, the fitting portions 29a of the first core member 24 are fitted into the fitting recesses 27b, respectively, of the second core member 25, and the fitting portions 29b of the second core member 25 are fitted into the fitting recesses 27a, respectively, of the first core member 24 to join the first core member 24 and the second core member 25 together via the adhesive.

In this state, the tubular portions 36 of the protective members 32 are inserted into the through hole 13 of the core 8, and the rotatable shaft 6 of the direct-current motor 1 is press fitted into the tubular portions 36 of the protective members 32. As a result, the outer peripheral surface of each tubular portion 36 is radially outwardly deformed, so that the outer peripheral surface of the tubular portion 36 presses the inner peripheral surface of the through hole 13. As a result, the core 8 is secured to the rotatable shaft 6, and the core 8 is centered with respect to the yoke 4.

Thereafter, the commutator 7 is secured to the rotatable shaft 6, and the end of each winding wire 23 is connected to the corresponding short-circuiting wire 11. Each short-circuiting wire 11 is connected to the corresponding group of the commutator segments 10 of the commutator 7. Thus, each winding wire 23 is electrically connected to the corresponding commutator segments 10 through the corresponding short-circuiting wire 11 to form the armature 3.

The above embodiment achieves the following advantages.

(1) The core 8 is covered by the two protective members 32. Thus, at the time of press fitting the rotatable shaft 6 into the protective members 32, the rotatable shaft 6 does not directly contact the core 8. Therefore, at the time of manufacturing the armature 3, damage to the core 8 can be advantageously limited.

(2) The rotatable shaft 6 is press fitted into the through hole 13 of the core 8 via the tubular portions 36 of the protective members 32. Thus, the load, which is applied from the press fitted rotatable shaft 6 to the core 8, is absorbed upon deformation of the tubular portions 36. As a result, the damage to the core 8, which would be caused by the press fitting of the rotatable shaft 6 into the through hole 13 of the core 8, can be advantageously limited.

Furthermore, in comparison to the case where the rotatable shaft 6 is directly press fitted into the through hole 13 of the core 8, which is made from the magnetic powder and thus has little or no ductility, a greater variation in a dimensional accuracy or quality of the inner diameter of the through hole 13 and a greater variation in a dimensional accuracy or quality of the outer diameter of the rotatable shaft 6 are allowed, that is, a greater variation in the fitting part dimensional accuracy of the core 8 and of the rotatable shaft 6 is allowed. More specifically, an error in the inner diameter of the through hole 13 and an error in the outer diameter of the rotatable shaft 6 are absorbed or alleviated through the deformation of the tubular portions 36, so that the rotatable shaft 6 can be more easily press fitted into the core 8. As a result, even when a substantial variation occurs in the dimensional quality of the core 8 and/or dimensional quality of the rotatable shaft 6, such a variation can be absorbed by the protective members 32. Thus, the core 8 and the rotatable shaft 6 are less wasted in the manufacturing process to improve the yield, and thereby the armature 3 can be manufactured at the reduced costs.

(3) The recesses 12 are formed in the portion of the outer peripheral surface of the rotatable shaft 6, to which the core 8 is secured. Thus, only the portions of the outer peripheral surface of the rotatable shaft 6 where no recess is made engage the inner peripheral surface of the tubular portion 36. As a result, the tubular portions 36 are less extended in the circumferential direction at the time of press fitting the rotatable shaft 6 into the tubular portions 36. Therefore, the load applied from the rotatable shaft 6 to the core 8 can be reduced to further limit damage to the core 8.

(4) Each annular disk portion 33 includes the engaging projections 34, and the engaging recesses 35 are provided in the axial end surfaces of the core 8. Thus, in the above case, each engaging projection 34 of each protective member 32 is engaged with the corresponding one of the engaging recesses 35 of the core 8, and thereby direct conduction of the load, which is exerted from the rotatable shaft 6 to the core 8 upon press fitting of the rotatable shaft 6, is limited. As a result, the damage to the core 8, which would be induced by the press fitting of the rotatable shaft 6, can be further limited.

Furthermore, it is only required that the outer diameter of each tubular portion 36 and the inner diameter of the through hole 13 are set to achieve transition fit or loose fit between the through hole 13 of the core 8 and each tubular portion 36, into which the rotatable shaft 6 is press fitted. Thus, a substantial variation in the dimensional accuracy of the inner diameter of the through hole 13 and a substantial variation in the dimensional accuracy of the outer diameter of each tubular portion 36 are allowed. As a result, the armature 3 can be manufactured at further reduced costs.

Also, since each engaging projection 34 is circumferentially engaged with the corresponding engaging recess 35, rotation of the core 8 relative to the protective members 32, into which the rotatable shaft 6 is press fitted, can be advantageously prevented. Thus, rotation of the core 8 relative to the rotatable shaft 6 can be prevented.

(5) The chamfered portions 27c, 27d are formed in the radial opening end edges of each fitting recess 27a, 27b. Furthermore, the chamfered portions 29c, 29d are formed in the end edges of the radially inner end of each fitting portion 29a, 29b. Thus, stresses applied to the radial opening end edges of each fitting recess 27a, 27b and stresses applied to the end edges of the radially inner end of each fitting portion 29a, 29b can be dispersed or alleviated. As a result, even in a case where an accuracy of an assembling apparatus, which assembles the first core member 24 and the second core member 25 together, is relatively low, damage to the first core member 24 and to the second core member 25 induced by collision between the first core member 24 and the second core member 25 can be advantageously limited.

(6) The chamfered portions 18a are formed in the opposed circumferential end edges of each extended portion 18 in such a manner that each chamfered portion 18a has the decreasing radial width, which decreases toward the corresponding circumferential end of the extended portion 18. Thus, at the time of mass production of the cores 8, at the time of transportation of the cores 8 and/or at the time of mass production of the direct-current motors 1, even when collision between one core 8 and another core 8 or collision between one core 8 and another component occurs, the stresses applied to the circumferential ends of each extended portion 18 can be alleviated, and damage to the first core member 24 and damage to the second core member 25 can be limited or minimized.

(7) Upon completion of manufacturing of the core 8, the space between the first core member 24 and the second core member 25 is filled with the adhesive, into which the magnetic metal powder is mixed. Thus, the magnetoresistance of the magnetic flux, which passes the space between the first core member 24 and the second core member 25, is reduced, and thereby it is possible to achieve a higher power of the direct-current motor 1.

(8) Each extended portion 18 is covered with the corresponding distal end insulating portion 21 formed in the insulator arrangement 19. Thus, shocks or mechanical impacts generated upon contact of the extended portion 18 with another component are not directly conducted to the extended portion 18 but are indirectly conducted to the extended portion 18 after absorption of some of the shocks through the insulator arrangement 19. Thus, damage to the extended portion 18 can be advantageously limited.

(9) The rotatable shaft 6 is press fitted into the through hole 13 of the core 8 via the tubular portions 36 of the protective members 32. Thus, unlike a case where the rotatable shaft 6 and the core 8 are bonded together without providing the protective members 32, or a case where resin is filled in a space between the rotatable shaft 6 and the core 8, it is possible to limit a decrease in the strength or to limit occurrence of creep deformation, which is caused by temperature change of the adhesive or the resin. As a result, the long time reliability of the direct-current motor 1 can be achieved.

The above embodiment can be modified as follows.

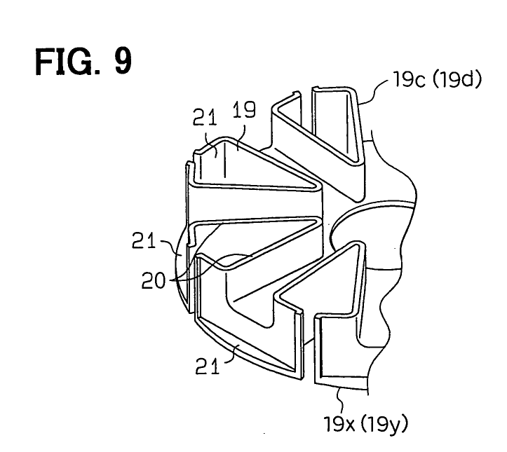

The armature 3 may include an insulator arrangement 19 of FIG. 9, which has a first side part 19x and a second side part 19y. The first side part 19x includes a plurality of first side insulator parts 19c, which correspond to the first side insulator parts 19a of the above embodiment but are integrally molded together, for example, from a dielectric resin material. Similarly, the second side part 19y includes a plurality of second side insulator parts 19d, which correspond to the second side insulator parts 19b of the above embodiment but are integrally molded together, for example, from a dielectric resin material. In this instance, the first side part 19x and the second side part 19y of the insulator arrangement 19 are axially installed to the core 8 after the first core member 24 and the second core member 25 are joined together. Thereafter, the winding wires 23 are wound around the wire winding portions 20. Since the first side insulator parts 19c and the second side insulator parts 19d can be installed to the teeth 15 in a single step, the above arrangement allows a reduction in a manufacturing time of the armature 3.

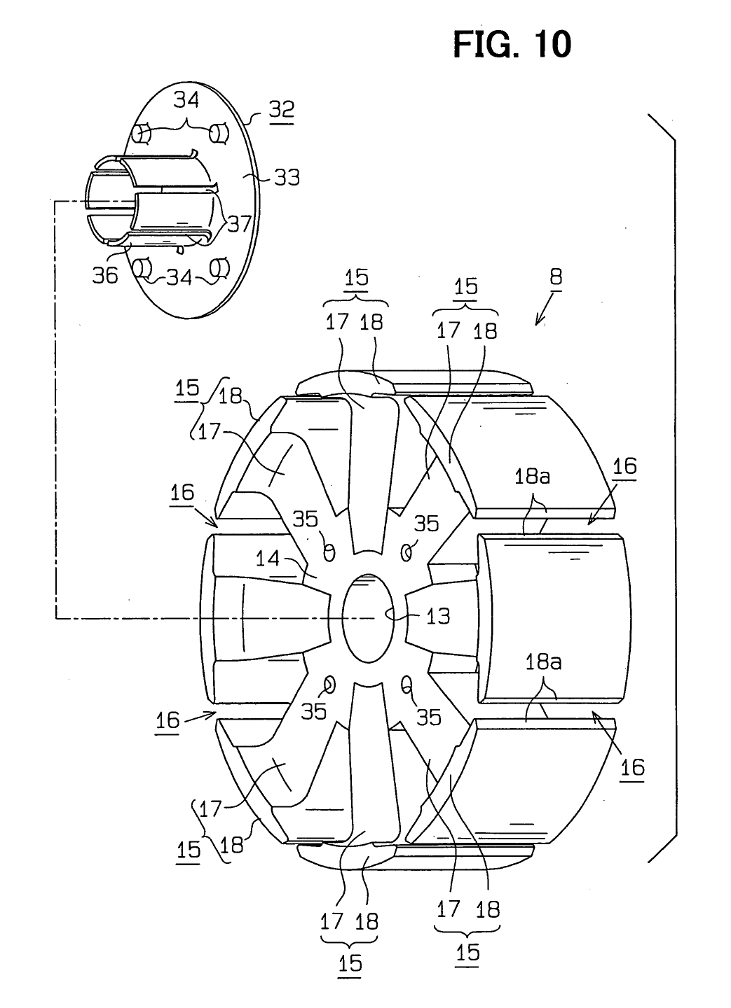

With reference to FIG. 10, as another modification of the above embodiment, a plurality of axial slits 37 may be arranged in each tubular portion 36 at generally equal angular intervals in the circumferential direction of the tubular portion 36 in such a manner that each axial slit 37 extends through the entire axial extent of the tubular portion 36. With this arrangement, the tubular portion 36 can be more easily extend, i.e., deformed in the circumferential direction. The load, which is applied from the press fitted rotatable shaft 6 to the core 8, is easily absorbed by extending the tubular portion 36 in the circumferential direction. As a result, the mechanical damage to the core 8, which would be caused by the press fitting of the rotatable shaft 6, can be more effectively limited. In this case, the recesses 12 (FIG. 2) can be eliminated from the outer peripheral surface of the rotatable shaft 6.

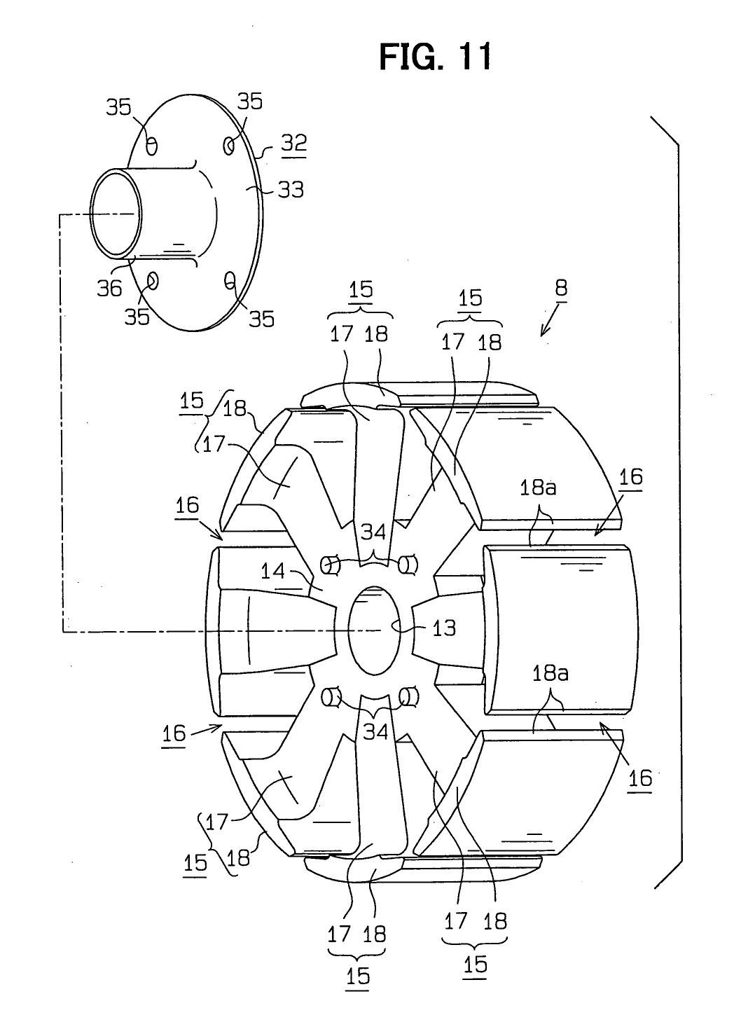

With reference to FIG. 11, as another modification of the above embodiment, four engaging recesses (or alternatively engaging through holes) 35 can be formed in each annular disk portion 33, and four engaging projections 34 can be formed in the corresponding opposed axial end surface of the core 8 to engage with the engaging recesses 35 of the annular disk portion 33. Also, the number of the engaging projections 34 and the number of the engaging recesses 35 can be modified to any other appropriate numbers.

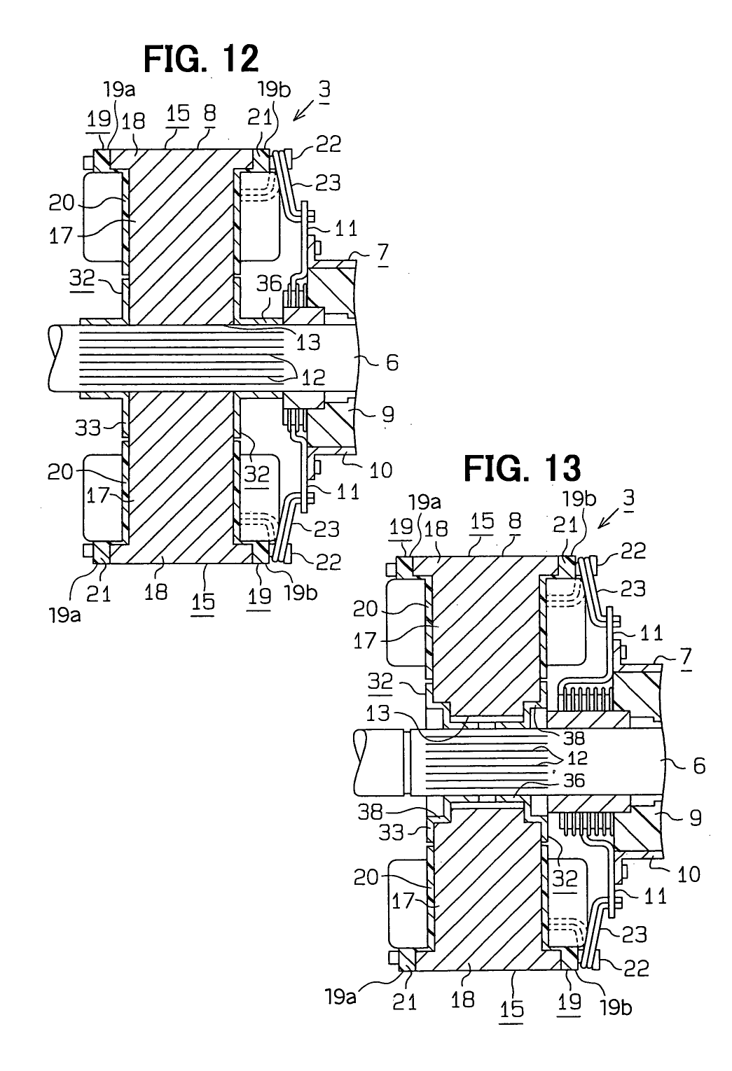

With reference to FIG. 12, as another modification of the above embodiment, the tubular portion 36 of each protective member 32 can be extended on an opposite side of the annular disk portion 33, which is opposite from the core 8. With this arrangement, the outer peripheral surface of the tubular portion 36 does not engage the inner peripheral surface of the through hole 13, so that a substantial variation in the outer diameter of the tubular portion 36 is allowed, and the number of manufacturing steps of the armature 3 can be reduced. As a result, the armature 3 can be manufactured at reduced costs.

With reference to FIG. 13, as another modification of the above embodiment, an axial length of an inner peripheral part of the core 8 can be set shorter than an axial length of the outer peripheral part or a radially intermediate part of the core 8, and a stepped portion 38 can be provided in each protective member 32 to serve as a support portion, which radially supports the core 8. An axially center part of the inner peripheral surface of the through hole 13 can be radially spaced apart from the outer peripheral surface of each tubular portion 36. With this arrangement, the outer peripheral surface of the rotatable shaft 6 only engages the opposed axial ends of the inner peripheral surface of the through hole 13 through the tubular portions 36 and the stepped portions 38. Thus, the load, which is applied from the press fitted rotatable shaft 6 to the core 8, can be absorbed by deformation of the tubular portions 36 and deformation of the stepped portions 38. As a result, the damage to the core 8, which would be caused by the press fitting of the rotatable shaft 6, can be further limited.

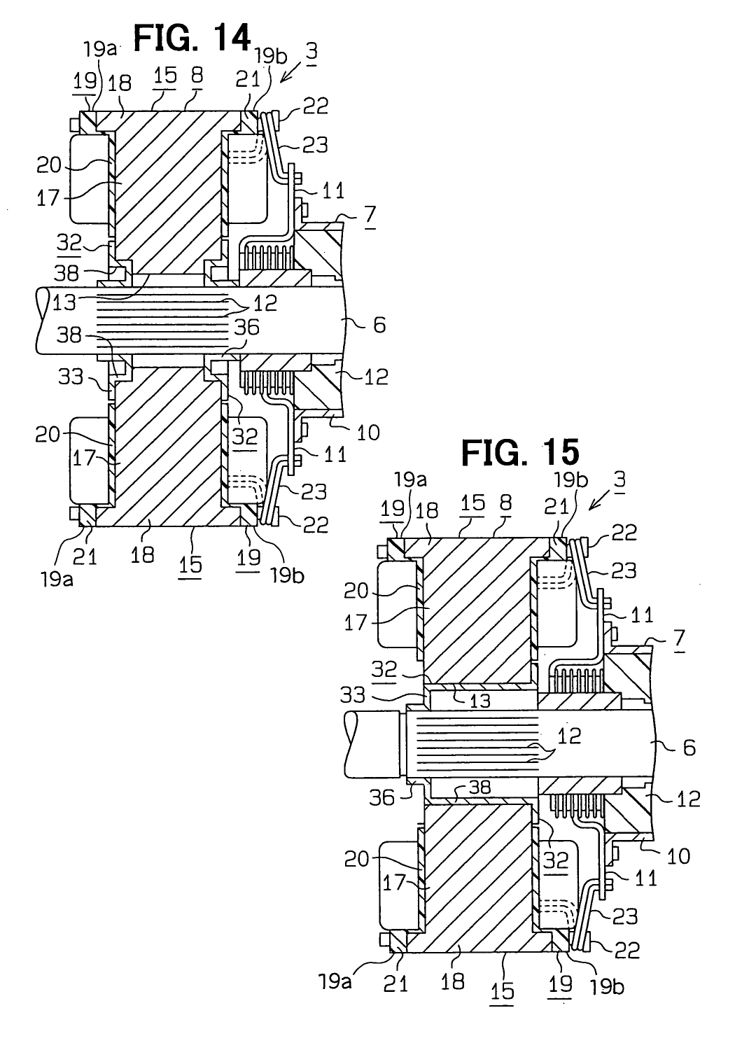

With reference to FIG. 14, as another modification of the above embodiment, an axial length of the inner peripheral part of the core 8 can be set shorter than an axial length of the outer peripheral part or radially intermediate part of the core 8, and a stepped portion 38 can be provided in each protective member 32 to serve as a support portion, which radially supports the core 8. Also, in this case, the tubular portion 36 of each protective member 32 can be extended on an opposite axial side of the annular disk portion 33, which is opposite from the core 8.

Also, in the case of FIG. 14, the inner peripheral part of the core 8 can have a tapered portion (not shown), which has a decreasing axial length that decreases toward the through hole 13 in the radial direction. Here, each of the stepped portions 38 can be formed to extend along the tapered portion.

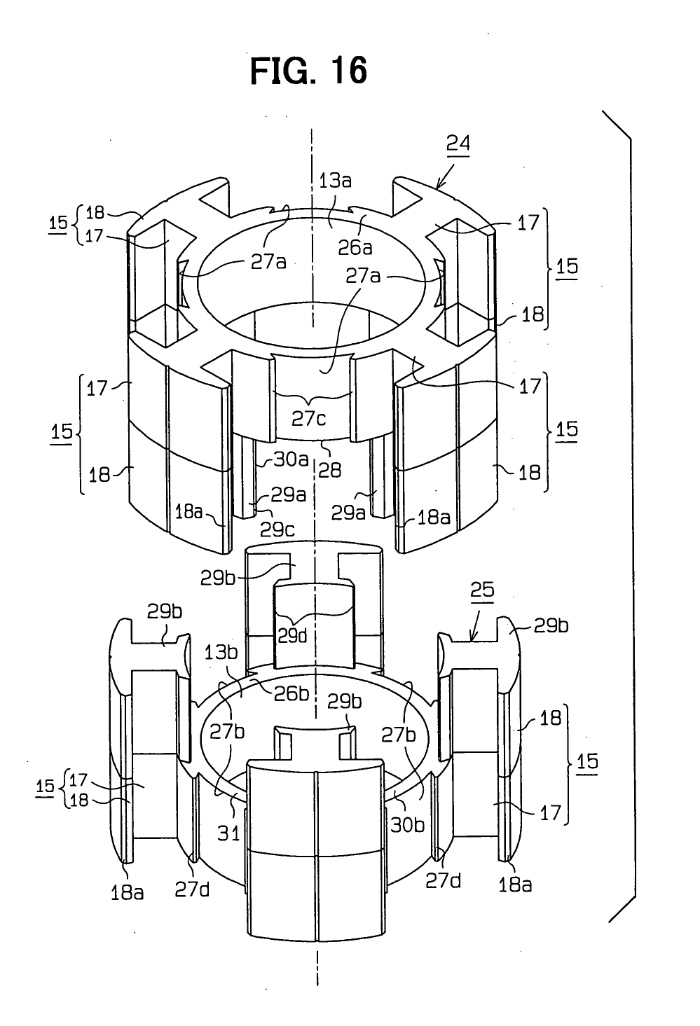

With reference to FIG. 15, as another modification of the above embodiment, a single protective member 32 is provided. In this modification, the axial length of the stepped portion 38 of the protective member 32 can be set to the same axial length as that of the inner peripheral part of the core 8, and the tubular portion 36 of the protective member 32 can be extended on an opposite axial side of the annular disk portion 33, which is opposite from the core 8. In this case, as shown in FIG. 16, the inner diameter of the through hole 13a of the first core member 24 and the inner diameter the through hole 13b of the second core member 25 are increased in comparison to those of the above embodiment. As shown in FIG. 17, the tubular portion 36 can be extended on the core 8 side of the annular disk portion 33. With this arrangement, the core 8 can be radially supported by the single protective member 32, and the number of components of the armature 3 can be reduced. As a result, the armature 3 can be manufactured at further reduced costs.

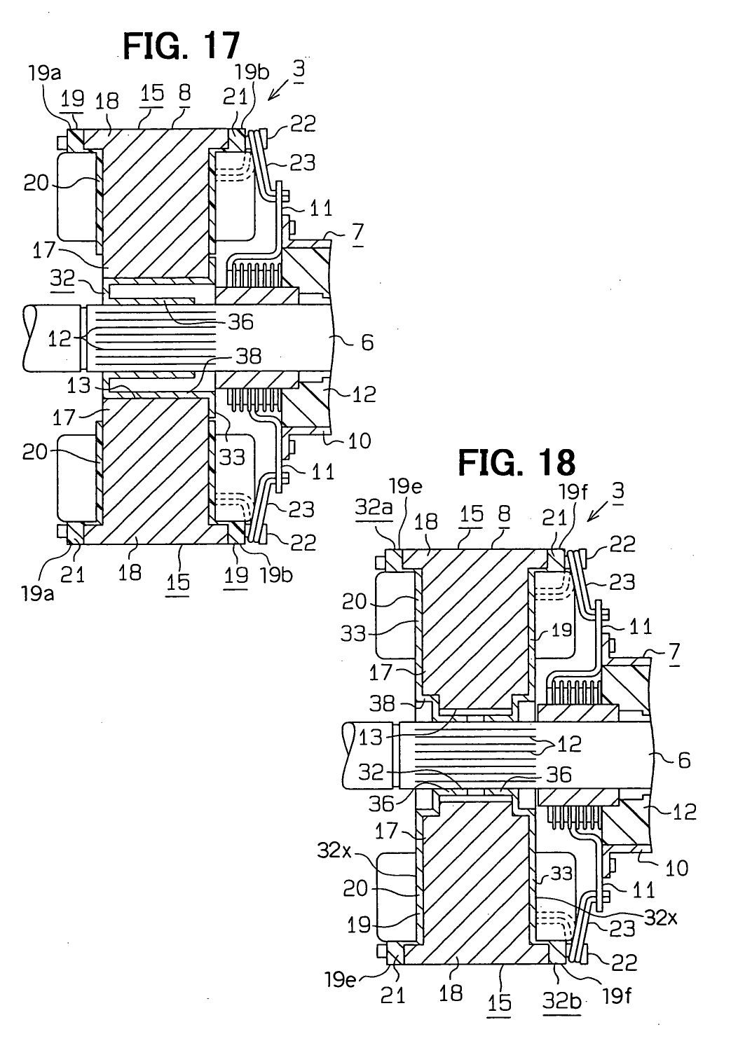

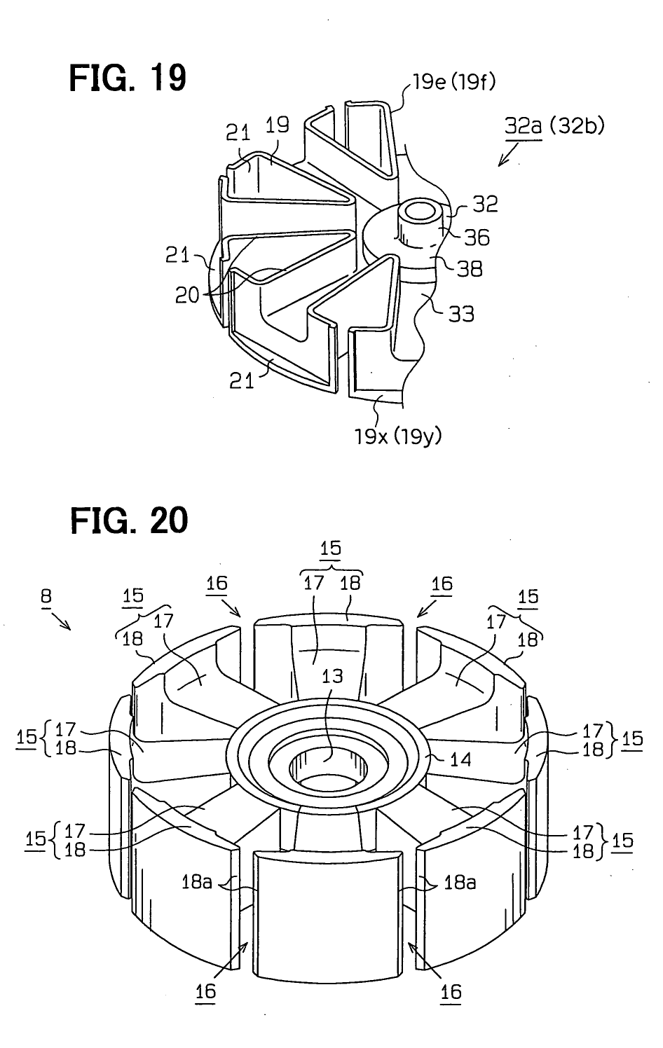

With reference to FIGS. 18 and 19, as another modification of the above embodiment, in place of the protective members 32 and the insulator arrangements 19 of the above embodiment, first and second protective members (also referred to as first side and second side parts of a single insulator arrangement) 32a, 32b can be provided. As shown in FIG. 19, the first protective member 32a includes a plurality of first side insulator parts 19e and a protective member part 32, which are integrated into a single body. The first side insulator parts 19e of FIG. 19 are similar to the first side insulator parts 19a of the above embodiment but are connected together. Also, the protective member part 32 of FIG. 19 is similar to the protective member 32 of the above embodiment but is integrated with the first side insulator parts 19e. The second side protective member 32b is similar to the first side protective member 32a except projections 22, which are similar to the projections 22 described above, and thus will not be described further. With this arrangement, the number of components of the armature 3 can be advantageously reduced, and the number of manufacturing steps of the armature 3 can be advantageously reduced. Thus, the armature 3 can be manufactured at lower costs. Also, as shown in FIG. 20, it is desirable to integrally make the core 8 from magnetic powder by compression molding.

Furthermore, in the case shown in FIG. 18, each protective member 32a, 32b can be made by press working of a magnetic metal plate material, and thereafter a surface of the protective member 32a, 32b can be insulated by a dielectric material. More specifically, a dielectric layer 32x can be coated on the surface of the protective member 32a through a chemical process or a heat treatment process. In this way, the magnetoresistance of the magnetic flux, which passes the protective member 32a, can be reduced, and thereby it is possible to increase the output power of the direct-current motor 1. Furthermore, even if the protective member 32a is made of a magnetic material, insulation between the core 8 and the winding wires 23 can be effectively achieved. Also, by thinning the dielectric layer, enlargement of the direct-current motor 1 can be prevented without sacrificing a space factor of the winding wires 23.

In the above embodiment and above modifications, the protective members 32, 32a, 32b can be made of a resilient synthetic resin material. With this arrangement, shocks, which are induced by engagement of the protective members 32, 32a, 32b with the rotatable shaft 6, can be further absorbed by the protective members 32, 32a, 32b. Thus, conduction of the shocks to the core 8 can be further limited. As a result, damage to the core 8 can be further limited.

In the above embodiment, the tubular portion 36 can be eliminated from each protective member 32.

In the above embodiment, each protective member 32 can be made by press working of a magnetic metal plate material. Also, a dielectric layer can be coated on a surface of the protective member 32 through a chemical process or a heat treatment process.

In the above embodiment, as shown in FIG. 20, the core 8 can be integrally formed from magnetic powder by compression molding.

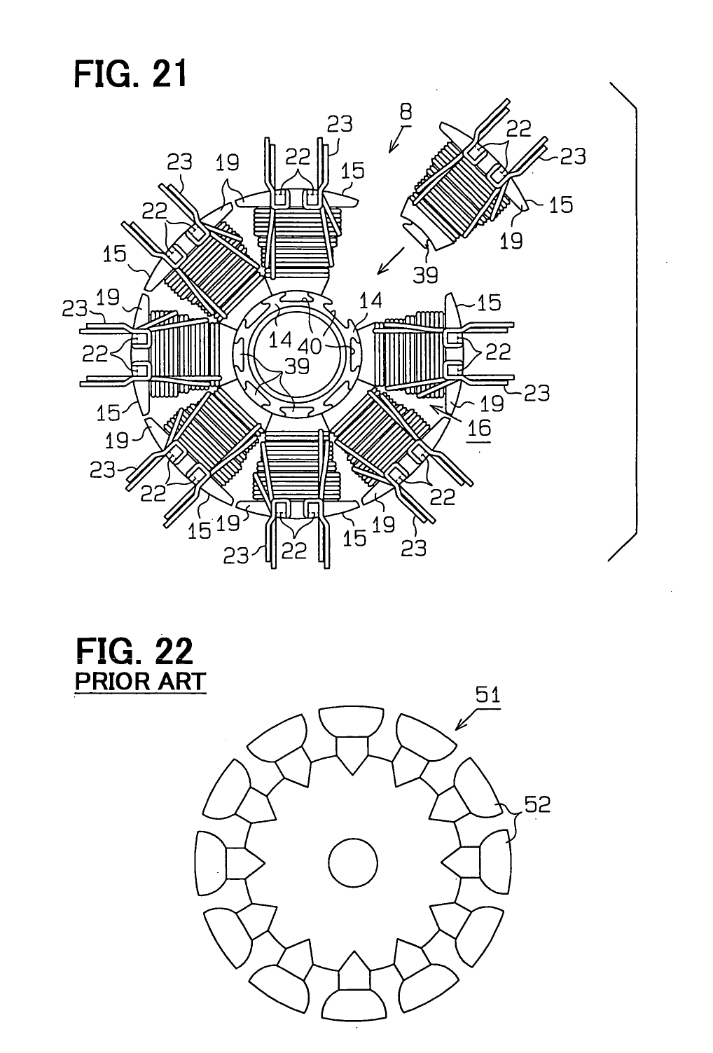

Also, as shown in FIG. 21, the core 8 can include a center core body 14 and a plurality of separately manufactured teeth 15. In such a case, a fitting projection 39 is provided in a radially inner end of each tooth 15 to extend in an axial direction of the tooth 15, and a plurality of fitting recesses 40, each of which is engaged with the corresponding fitting projection 39, is formed in an outer peripheral part of the center core body 14. With this arrangement, when the fitting projections 39 are respectively engaged with the fitting recesses 40, the teeth 15 are installed to the center core body 14 to form the core 8.

In the above embodiment, the chamfered portions 18a, 27c, 27d, 29c, 29d can be eliminated from the radial opening end edges of the fitting recesses 27a, 27b, the end edges of the radially inner ends of the fitting portions 29a, 29b and the end edges of the extended portions 18.

In the above embodiment, the magnetic metal powder can be eliminated from the adhesive, which is used to bond between the first core member 24 and the second core member 25.

In the above embodiment, each tooth main body 17 and each extend portion 18 are covered by the corresponding insulator arrangement 19. However, a portion of the insulator arrangement 19 can be eliminated from the extended portion 18, so that the insulator arrangement 19 only covers the tooth main body 17.

In the above embodiment, the number of teeth 15 is eight. However, the number of the teeth 15 is not limited to eight and can be changed to any appropriate number. Also, the number of magnets 5 is not limited to six and can be changed to any appropriate number. That is, the direct-current motor 1 is not limited to the above described one, which has the six poles, eight slots and twenty four commutator segments.

Additional advantages and modifications will readily occur to those skilled in the art. The invention in its broader terms is therefore not limited to the specific details, representative apparatus, and illustrative examples shown and described.

What is claimed is:

1. An armature comprising:
a rotor core that includes a plurality of teeth, each of which extends in a radial direction of the rotor core;
a plurality of winding wires, each of which is wound around a corresponding one of the teeth;
at least one insulator arrangement that electrically insulates between the rotor core and the winding wires; and
at least one protective member that is provided to the rotor core to protect the rotor core from mechanical damage.

2. The armature according to claim 1, wherein the at least one protective member is made of a synthetic resin material.

3. The armature according to claim 1, wherein at least one of the at least one protective member is integrated with at least one of the at least one insulator arrangement.

4. The armature according to claim 1, further comprising a rotatable shaft that is connected to the rotor core, wherein:
the rotor core further includes a through hole that axially penetrates through the rotor core and receives the rotatable shaft therethrough; and
the at least one protective member includes at least one tubular portion, into which the rotatable shaft is press fitted, wherein the at least one tubular portion is engaged with an inner peripheral surface of the through hole.

5. The armature according to claim 4, wherein each tubular portion includes a plurality of slits, each of which extends in an axial direction of the armature.

6. The armature according to claim 4, wherein the rotatable shaft includes a plurality of recesses that are formed in a portion of an outer peripheral surface of the rotatable shaft, which contacts the at least one tubular portion, wherein the recesses extend in an axial direction of the armature and are spaced from one another in a circumferential direction of the armature.

7. The armature according to claim 4, wherein the at least one tubular portion includes two tubular portions which are spaced from one another in an axial direction of the armature.

8. The armature according to claim 1, wherein the at least one protective member includes at least one disk portion, each of which engages a corresponding one of two opposed axial end surfaces of the rotor core.

9. The armature according to claim 8, wherein:
one of the rotor core and each disk portion has at least one first type engaging portion; and
the other one of the rotor core and each disk portion has at least one second type engaging portion, each of which engages a corresponding one of the at least one first type engaging portion in a circumferential direction and a radial direction of the armature.

10. The armature according to claim 1, wherein the rotor core includes:
a first core member, which includes:
a first half of the plurality of teeth; and
one of at least one fitting recess and at least one fitting portion, which engages the at least one fitting recess; and
a second core member, which engages the first core member and includes:
a second half of the plurality of teeth; and
the other one of the at least one fitting recess and the at least one fitting portion, wherein at least one of opening end edges of the at least one fitting recess and end edges of the at least one fitting portion is chamfered.

11. The armature according to claim 1, wherein each tooth includes an extended portion that protrudes from the rest of the tooth in a circumferential direction of the armature, and at least one of two opposed circumferential end edges of the extended portion of each tooth is chamfered.

12. The armature according to claim 1, wherein:
the at least one protective member is made of a magnetic metal plate material; and
the at least one insulator arrangement includes a dielectric layer coated on a surface of each protective member.

13. The armature according to claim 1, wherein the rotor core is made from magnetic powder by compression molding.

14. The armature according to claim 1, wherein:
the at least one insulator arrangement includes a plurality of insulator arrangements, which are provided to the teeth, respectively; and
each insulator arrangement includes a first insulator part and a second insulator part, which are installed to the corresponding tooth in an axial direction of the armature and are opposed to one another in the axial direction of the armature.

15. The armature according to claim 1, wherein the at least one insulator arrangement includes an insulator arrangement that has first side part and a second side part, which are opposed to one another in an axial direction of the armature and hold the plurality of teeth therebetween.
